(19) United States
(12) Patent Application Publication
(10) Pub. No.: US 2008/0216934 A1
(43) Pub. Date: Sep. 11, 2008

(54) Tire with sidewall comprised of low viscosity trans 1,4-polybutadiene, cis 1,4-polyisoprene rubber and cis 1,4-polybutadiene rubber

(76) Inventor: Paul Harry Sandstrom, Cuyahoga Falls, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/715,586

(22) Filed: Mar. 8, 2007

(51) Int. Cl. B60C 1/00

(52) U.S. Cl. 152/525

(57) ABSTRACT

This invention relates to a tire with a sidewall composition comprised of cis 1,4-polyisoprene rubber, particularly natural rubber, and high cis 1,4-polybutadiene rubber combined with a partial replacement of the cis 1,4-polyisoprene rubber with a low Mooney viscosity specialized trans 1,4-polybutadiene.

### FIELD OF THE INVENTION

This invention relates to a tire with a sidewall composition comprised of cis 1,4-polyisoprene rubber, particularly natural rubber, and high cis 1,4-polybutadiene rubber combined with a partial replacement of the cis 1,4-polyisoprene rubber with a low Mooney viscosity specialized trans 1,4-polybutadiene.

### BACKGROUND OF THE INVENTION

A challenge is presented of replacing a portion of cis 1,4-polyisoprene rubber, particularly natural rubber, with a synthetic polymer (other than synthetic cis 1,4-polyisoprene rubber) in a tire sidewall composition which is normally comprised of natural rubber (or synthetic natural rubber) and cis 1,4-polybutadiene rubber to achieve a rubber composition of similar physical properties. A motivation for such challenge is a desire for a natural rubber alternative, at least a partial alternative, in a form of a synthetic rubber to offset relative availability and/or cost considerations of natural rubber.

Therefore, such challenge has been undertaken to evaluate the feasibility of replacing a portion of cis 1,4-polyisoprene rubber, particularly natural rubber, in a tire sidewall with a synthetic rubber.

It is to be appreciated that cis 1,4-polyisoprene rubber may be in a form of natural rubber and of synthetic cis 1,4-polyisoprene rubber (synthetic natural rubber). It is to be further appreciated that such natural rubber may be derived from, for example, trees and plants such as, for example, guayule plants and that such synthetic rubber may be derived from, for example, various chemical processes, whether by industrial, laboratory or other process.

While this presentation is primarily focused on replacement of a portion of natural cis 1,4-polyisoprene rubber in a rubber composition, it is intended herein that at least a portion of such natural rubber may be a synthetic cis 1,4-polyisoprene rubber.

In practice, pneumatic rubber tires conventionally have relatively thin rubber sidewalls which are normally subjected to significant punishment under typical operating conditions by undergoing considerable dynamic distortion and flexing, abrasion due to scuffing, fatigue cracking and weathering such as, for example, atmospheric ozone aging.

Significant physical properties for natural rubber/high cis 1,4-polybudadiene rubber based tire sidewall rubber compositions are considered herein to be, for example, rebound (at 100° C.) and tan delta (at 100° C.) which contribute to rolling resistance of the tire and therefore fuel economy of the associated vehicle, with higher values being desired for the Rebound property and lower values being desired for the tan delta property.

Additional desirable physical properties are considered herein to be higher low strain stiffness properties (e.g. low, 10 percent strain), in combination with the above rebound and tan delta properties, as indicated by Shore A hardness values and dynamic modulus G′ at 10 percent strain values at 100° C. to promote handling for the tire and resistance to sidewall wear.

Further desirable properties which might be desired for the sidewall rubber composition include relatively high tear strength to promote resistance to sidewall damage as well as building tack for the uncured rubber composition and the aforesaid ozone weathering resistance for the visible, exposed, rubber sidewall.

Accordingly, it is readily seen that a partial substitution of a synthetic rubber for a portion of the natural rubber in such tire sidewall rubber composition is not a simple matter and requires more than routine experimentation, where it is desired to substitute a portion of the natural rubber with a synthetic rubber and to substantially retain, or improve upon, a suitable balance of the representative physical properties of a natural rubber/high cis 1,4-polybutadiene sidewall rubber composition.

For this invention, it is proposed to use a specialized, low Mooney viscosity, low vinyl, trans 1,4-polybutadiene polymer (prepared by polymerizing 1,3-butadiene in the presence of a barium-based catalyst system) for partial replacement of the natural rubber in the tire sidewall rubber composition having, in its uncured state, a relatively low Mooney (ML 1+4) viscosity (100° C.) within a range of from 10 to 45, alternately and preferably within a range of from 15 to 35. It is comprised of a trans 1,4-microstructure having a range of from 70 to 90 percent, alternately and preferably from about 75 to about 85 percent, of its repeat units of a trans 1,4-isomeric structure, about 10 to about 20 percent of its units of a cis 1,4-isomeric structure and a very low vinyl 2,1-content of from about 3 to about 5 percent, and preferably has a glass transition temperature (Tg) within a range of about −85° C. to about −95° C. In one embodiment, the specialized trans 1,4-polybutadiene polymer for this invention has an Mw (weight average molecular weight) below 220,000 and an Mn (number average molecular weight) below 120,000, thereby contributing to its low Mooney viscosity. The specialized low Mooney viscosity trans 1,4-polybutadiene for use in this invention is prepared by polymerization of 1,3-butadiene in an organic solvent (e.g. hexane) in the presence of a barium-based catalyst system, as described in U.S. Pat. No. 6,626,715, comprised of a barium salt of di(ethylene glycol)ethylether (BaDEGEE), tri-n-octylaluminum (TOA) and n-butyllithium (n-BuLi), and optionally containing an amine, so long as the specialized trans 1,4-polybutadiene has the aforesaid relatively low Mooney viscosity.

Accordingly, in order to provide the specialized trans 1,4-polybutadiene with the aforesaid relatively low Mooney viscosity for use in this invention, a significant aspect of this invention is an exclusion of a trans 1,4-polybutadiene, particularly a crystalline trans 1,4-polybutadiene, prepared by polymerization of 1,3-butadiene in an organic solvent in the presence of a cobalt-based catalyst system and carbon disulfide gel inhibitor, as described in U.S. Pat. No. 5,089,574, comprised of an organocobalt compound (e.g. at least one of cobalt naphthenate, cobalt octanoate and cobalt neodecanoate, particularly cobalt octanoate), organoaluminum compound (e.g. triethylaluminum) and para-substituted phenol (e.g. para-dodecylphenol), for which it is understood that such crystalline trans 1,4-polybutadiene is not readily available having a combination of said low Mooney viscosity and said low vinyl 1,2-content.

A reference to glass transition temperature, or Tg, of an elastomer or sulfur vulcanizable polymer, particularly the specialized trans 1,4-polybutadiene polymer, represents the onset glass transition temperature of the respective elastomer or sulfur vulcanizable polymer in its uncured state. The Tg can be suitably determined by a differential scanning calorimeter (DSC) at a temperature rate of increase of 10° C. per minute, (ASTM 3418), a procedure well known to those having skill in such art.

A reference to melt point, or Tm, of a sulfur vulcanizable polymer, particularly the specialized trans 1,4-polybutadiene polymer, represents its melt point temperature in its uncured state, using basically the same or similar procedural method as for the Tg determination, using a temperature rate of increase of 10° C. per minute, a procedure understood by one having skill in such art.

A reference to molecular weight, such as a weight average molecular weight (Mw), or number average molecular weight (Mn), of an elastomer or sulfur vulcanizable polymer, particularly the specialized trans 1,4-polybutadiene polymer, represents the respective molecular weight of the respective elastomer or sulfur vulcanizable polymer in its uncured state. The molecular weight can be suitably determined by GPC (gel permeation chromatograph instrument) analysis, a procedural molecular weight determination well known to those having skill in such art.

A reference to Mooney (ML 1+4) viscosity of an elastomer or sulfur vulcanizable polymer, particularly the specialized trans 1,4-polybutadiene polymer, represents the viscosity of the respective elastomer or sulfur vulcanizable polymer in its uncured state. The Mooney (ML 1+4) viscosity at 100° C. relates to its “Mooney Large” viscosity, taken at 100° C. using a one minute warm up time and a four minute period of viscosity measurement, a procedural method well known to those having skill in such art.

In the description of this invention, the terms “compounded” rubber compositions and “compounds”, where used refer to the respective rubber compositions which have been compounded with appropriate compounding ingredients such as, for example, carbon black, oil, stearic acid, zinc oxide, silica, wax, antidegradants, resin(s), sulfur and accelerator(s) and silica and silica coupler where appropriate. The terms “rubber” and “elastomer” may be used interchangeably. The amounts of materials are usually expressed in parts of material per 100 parts of rubber polymer by weight (phr).

### DISCLOSURE AND PRACTICE OF THE INVENTION

In accordance with this invention, a tire having an outer, visible, rubber sidewall is provided wherein said sidewall is a rubber composition comprised of, based upon parts by weight per 100 parts by weight rubber (phr):

(A) from about 5 to about 35 phr, alternately from about 5 to about 30 phr, of a specialized trans 1,4-polybutadiene polymer having a microstructure containing from about 70 to about 90, preferably from 75 to about 85, percent trans 1,4-units, a Mooney (ML 1+4) viscosity at 100° C. in a range of from 10 to 45, alternately from 15 to 35, in its uncured state, a Tg in a range of from about −85° C. to about −95° C., and optionally an Mw (weight average molecular weight) below 220,000 and an Mn (number average molecular weight) below 120,000;

(B) from about 10 to about 40 phr of cis 1,4-polyisoprene rubber comprised of at least one of natural and synthetic cis 1,4-polyisoprene rubber, preferably natural rubber, having a Mooney (ML 1+4) viscosity (100° C.) in a range of about 60 to about 100 in its uncured state;

(C) from about 50 to about 70 phr cis 1,4-polybutadiene rubber; and

(D) from about 30 to about 80, alternately from about 40 to about 75, phr of particulate reinforcing fillers comprised of:
(1) about 30 to about 80, alternately from about 35 to about 70, phr of rubber reinforcing carbon black, and, optionally;
(2) from zero to about 30, alternately from about 5 to about 20, phr of amorphous synthetic silica, preferably precipitated silica.

In practice, said tire is provided as a sulfur cured rubber composite wherein said sidewall rubber composition is therefore a sulfur cured rubber composition.

The silica (e.g. precipitated silica), if used, may be used to the exclusion of, or optionally, and if desired, used in conjunction with a silica coupler to couple the silica to the elastomer(s), to thus enhance its effect as reinforcement for the elastomer composition. Use of silica couplers for such purpose are well known and typically have a moiety reactive with hydroxyl groups (e.g. silanol groups) on the silica and another moiety interactive with the elastomer(s) to create the silica-to-rubber coupling effect.

As hereinbefore pointed out, the specialized trans 1,4-polybutadiene polymer has a microstructure composed of about 75 to about 85 percent of its repeat units of a trans 1,4-isomeric structure, about 10 to about 20 percent of its units of a cis 1,4-isomeric structure and about 3 to about 5 percent of its units of a vinyl 1,2-structure.

In practice, the specialized trans 1,4-polybutadiene polymer has dual melting points (Tms) within a temperature range of from 10° C. to 45° C. which are composed of a first melting point in a range of from about 15° C. to about 25° C. and a second, spaced apart melting point in a range of from about 25° C. to about 40° C., wherein said second melting point is spaced apart from said first melting point by at least 5° C.

The specialized trans 1,4-polybutadiene polymer may be prepared, for example, by polymerization in an organic solvent in the presence of a catalyst composite composed of the barium salt of di(ethylene glycol)ethylether (BaDEGEE), tri-n-octylaluminum (TOA) and n-butyl lithium (n-BuLi) in a molar ratio of the BaDEGEE to TOA to n-BuLi in a range of about 1:4:3, which is intended to be an approximate molar ratio, so long as the resulting trans 1,4-polybutadiene polymer is the said specialized trans 1,4-polybutadiene polymer which is considered herein to not require undue experimentation by one having skill in such art. For example, see U.S. Patent Application 2005/0245688-A1 in which such trans 1,4-polybutadiene is used to replace a portion of natural rubber in a natural rubber-rich tire tread.

For example, the catalyst composite may be composed of about 7.2 ml of about a 0.29 M solution of the barium salt of di(ethylene glycol)ethylether (BaDEGEE) in suitable solvent such as, for example, ethylbenzene, about 16.8 ml of about a 1 M solution of tri-n-octylaluminum (TOA) in a suitable solvent such as, for example, hexane and about 7.9 ml of about a 1.6 M solution of n-butyl lithium (n-BuLi) in a suitable solvent such as, for example, hexane. The molar ratio of the three catalyst components, namely the BaDEGEE to TOA to n-BuLi may be, for example, said about 1:4:3.

As disclosed in U.S. Pat. No. 6,627,715, a four component catalyst system which consists of the barium salt of di(ethylene glycol)ethylether (BaDEGEE), amine, the tri-n-ocytylaluminum (TOA) and the n-butyl lithium (n-BuLi) may also be used to prepare high trans 1,4-polybutadiene polymers for use as a partial replacement of natural rubber in a natural rubber-rich tread rubber composition. The molar ratio of the BaDEGEE, to amine to TOA to n-BuLi catalyst components is about 1:1:4:3, which is intended to be an approximate ratio in which the amine can be a primary, secondary or tertiary amine and may be a cyclic, acyclic, aromatic or aliphatic amine, with exemplary amines being, for example, n-butyl amine, isobutyl amine, tert-butyl amine, pyrrolidine, piperidine and TMEDA (N,N,N′,N′-tetramethylethylenediamine, preferably pyrrolidine, so long as the resulting trans 1,4-polybutadiene polymer is the said specialized trans 1,4-polybutadiene polymer which is considered herein to not require undue experimentation by one having skill in such art.

In one aspect, the catalyst composite may be pre-formed prior to introduction to the 1,3-butadiene monomer or may be formed in situ by separate addition, or introduction, of the catalyst components to the 1,3-butadiene monomer so long as the resulting trans 1,4-polybutadiene polymer is the aforesaid specialized trans 1,4-polybutadiene polymer. The pre-formed catalyst composite may, for example, be a tri-component pre-formed composite comprised of all three of the BaDEGEE, TOA and BuLi components prior to introduction to the 1,3-butadiene monomer or may be comprised of a dual pre-formed component composite comprised of the BaDEGEE and TOA components to which the n-BuLi component is added prior to introduction o the 1,3-butadiene monomer.

In one aspect, the organic solvent polymerization may be conducted as a batch or as a continuous polymerization process. Batch polymerization and continuous polymerization processes are, in general, well known to those having skill in such art.

As hereinbefore mentioned, a coupling agent may, if desired, be utilized with the silica to aid in its reinforcement of the rubber composition which contains the silica. Such coupling agent conventionally contains a moiety reactive with hydroxyl groups on the silica (e.g. precipitated silica) and another and different moiety interactive with the diene hydrocarbon based elastomer.

In practice, said coupling agent for said optional silica reinforcement, if used, may be, for example,

(A) a bis-(3-triakloxysilylalkyl)polysulfide such as, for example, a bis-(3-triethoxysilylpropyl)polysulfide, having an average of from 2 to about 4 and more preferably an average of from 2 to about 2.6 or from about 3.4 to about 4, connecting sulfur atoms in its polysulfidic bridge, or

(B) a bis-(3-triethoxysilylpropyl)polysulfide having an average of from about 2 to about 2.6 connecting sulfur atoms in its polysulfidic bridge or a bis-(3-triethoxysilylpropyl)polysulfide having an average of from about 3.4 to about 4 connecting sulfur atoms in its polysulfidic bridge, wherein said polysulfide having an average of from 2 to about 2.6 connecting sulfur atoms in its polysulfidic bridge (to the exclusion of such polysulfide having an average of from 3 to 4 connecting sulfur atoms in its polysulfidic bridge) is blended with said rubber composition in the absence of sulfur and sulfur vulcanization accelerator and wherein said polysulfide having an average of from about 3.4 to about 4 connecting sulfur atoms in its polysulfidic bridge is thereafter blended with said rubber composition in the presence of sulfur and at least one sulfur vulcanization accelerator, or

(C) an organoalkoxymercaptosilane composition of the general Formula (I) represented as:

(X)ₙ(R₇O)₃₋ₙ—Si—R₈—SH (I)

wherein X is a radical selected from a halogen, namely chlorine or bromine and preferably a chlorine radical, and from alkyl radicals having from one to 16, preferably from one through 4, carbon atoms, preferably selected from methyl, ethyl, propyl (e.g. n-propyl) and butyl (e.g. n-butyl) radicals; wherein R₇ is an alkyl radical having from 1 through 18, alternately 1 through 4, carbon atoms preferably selected from methyl and ethyl radicals and more preferably an ethyl radical; wherein R₈ is an alkylene radical having from one to 16, preferably from one through 4, carbon atoms, preferably a propylene radical; and n is an average value of from zero through 3, preferably zero, and wherein, in such cases where n is zero or 1, R₇ may be the same or different for each (R₇O) moiety in the composition, and

(D) said organalkoxyomercaptosilane of the general Formula (I) capped with a moiety which uncaps the organoalkoxymercaptosilane upon heating to an elevated temperature.

Representative examples of various organoalkoxymercaptosilanes are, for example, triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, tripropoxy mercaptopropyl silane, ethoxy dimethoxy mercaptopropylsilane, ethoxy diisopropoxy mercaptopropylsilane, ethoxy didodecyloxy mercaptopropylsilane and ethoxy dihexadecyloxy mercaptopropylsilane.

Such organoalkoxymercaptosilanes may be capped with various moieties as discussed above.

A representative example of a capped organoalkoxymercaptosilane coupling agent useful for this invention is a liquid 3-octanoylthio-1-propyltriethoxysilane as an NXT™ Silane from Momentive Performance Materials, formerly GE Silicones, as well as organomercaptosilane oligomers from Momentive Performance Materials.

The coupling agent may, for example, be added directly to the elastomer mixture or may be added as a composite of precipitated silica and such coupling agent formed by treating a precipitated silica therewith or by treating a colloidal silica therewith and precipitating the resulting composite.

For example, said optional silica (e.g. precipitated silica), or at least a portion of said optional silica, may be pre-treated prior to addition to said elastomer(s):

(A) with an alkylsilane of the general Formula (II), or

(B) with said bis(3-triethoxysilylpropyl)polysulfide having an average of from about 2 to about 4 connecting sulfur atoms in its polysulfidic bridge, or

(C) with an organomercaptosilane such as, for example, said organomercaptosilane of the general Formula (I), or

(D) with a combination of said alkylsilane of general Formula (I) and said bis(3-triethoxysilylpropyl)polysulfide having an average of from about 2 to about 4 connecting sulfur atoms in its polysulfidic bridge, or

(E) with a combination of said alkylsilane of general Formula (II) and said organomercaptosilane;

wherein said alkylsilane of the general Formula (I) is represented as:

Xₙ—Si—R₆₍₄₋ₙ₎ (II)

wherein R₆ is an alkyl radical having from 1 to 18 carbon atoms, preferably from 1 through 4 carbon atoms; n is a value of from 1 through 3; X is a radical selected from the group consisting of halogens, preferably chlorine, and alkoxy groups selected from methoxy and ethoxy groups, preferably an ethoxy group.

A significant consideration for said pre-treatment of said silica is to reduce, or eliminate, evolution of alcohol in situ within the rubber composition during the mixing of the silica with said elastomer such as may be caused, for example, by reaction such coupling agent contained within the elastomer composition with hydroxyl groups (e.g. silanol groups) contained on the surface of the silica.

Representative of additional synthetic diene based elastomers for said tire sidewall rubber composition are, for example, synthetic cis 1,4-polyisoprene rubber and styrene/butadiene copolymer rubber.

It is readily understood by those having skill in the art that the rubber compositions would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins, the aforesaid optional silica, and plasticizers, fillers, pigments, fatty acid, zinc oxide, microcrystalline waxes, antioxidants and antiozonants, peptizing agents and carbon black reinforcing filler. As known to those skilled in the art, depending on the intended use of the sulfur vulcanizable and sulfur-vulcanized material (rubbers), the additives mentioned above are selected and commonly used in conventional amounts.

The vulcanization is conducted in the presence of a sulfur-vulcanizing agent. Examples of suitable sulfur vulcanizing agents include elemental sulfur (free sulfur) or sulfur donating vulcanizing agents, for example, an amine disulfide, polymeric polysulfide or sulfur olefin adducts. Preferably, the sulfur-vulcanizing agent is elemental sulfur.

Accelerators are used to control the time and/or temperature required for vulcanization and to improve the properties of the vulcanizate. In one embodiment, a single accelerator system may be used, i.e., primary accelerator. In another embodiment, combinations of two or more accelerators in which the primary accelerator is generally used in the larger amount, and a secondary accelerator which is generally used in smaller amounts in order to activate and to improve the properties of the vulcanizate. Combinations of these accelerators have been known to produce a synergistic effect on the final properties and are somewhat better than those produced by use of either accelerator alone. In addition, delayed action accelerators may be used which are not affected by normal processing temperatures but produce satisfactory cures at ordinary vulcanization temperatures. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

The tire can be built, shaped, molded and cured by various methods which will be readily apparent to those having skill in such art.

The invention may be better understood by reference to the following example in which the parts and percentages are by weight unless otherwise indicated.

### EXAMPLE I

Experiments were conducted to evaluate the feasibility of replacing a portion of natural rubber in a rubber composition comprised of natural rubber and cis 1,4-polybudiene rubber with a specialized low Mooney viscosity specialized trans 1,4-polybutadiene rubber.

An exemplary low Mooney viscosity specialized trans 1,4-polybutadiene is prepared by polymerization of 1,3-butadiene in an organic hexane solvent in the presence of a barium-based catalyst system comprised of a barium salt of di(ethylene glycol)ethylether (BaDEGEE), tri-n-octylaluminum (TOA) and n-butyllithium (n-BuLi) to prepare such specialized trans 1,4-polybutadiene having a Mooney (100° C.) viscosity (ML1+4) values of from 16 to 79 for Example III herein, including a Mooney (100° C.) viscosity of about 32 for Examples I and II herein as mentioned in the Examples of aforesaid U.S. Patent Application 2005/0245688-A1 and in aforesaid U.S. Pat. No. 6,626,715.

Rubber composition Samples A through H were prepared, with Sample A being a Control Sample which did not contain the trans 1,4-polybutadiene.

The rubber composition samples were prepared by mixing the elastomers(s) together with reinforcing fillers and other rubber compounding ingredients in a first non-productive mixing stage (NP) an internal rubber mixer for about 4 minutes to a temperature of about 160° C. The resulting mixture is then mixed in a productive mixing stage (P) in an internal rubber mixer with sulfur curative for about 2 minutes to a temperature of about 115° C. The rubber composition is cooled to below 40° C. between the non-productive mixing step and the productive mixing step.

The basic formulation for the rubber samples is presented in the following Table 1 expressed in parts by weight per 100 parts of rubber unless otherwise indicated.

TABLE 1

| | Parts |
|---|---|
| First Non-Productive Mixing Step (Mixed to 160° C.) | |
| Cis 1,4-polybutadiene rubber¹ | 60 |
| Natural cis 1,4-polyisoprene rubber (TRS 20) | 0 to 40 |
| Specialized trans 1,4-polybutadiene rubber² | 0 to 40 |
| Carbon black³ | variable |
| Oil, wax and tackifer | 18 |
| Fatty acid⁴ | 1 |
| Antioxidant and antiozonant⁵ | 5 |
| Zinc oxide | 3 |
| Productive Mixing Step (Mixed to 115° C.) | |
| Sulfur | variable |
| Accelerator(s)⁶ | 0.6 |

¹Obtained as BUD1207 ™ from The Goodyear Tire & Rubber Company
²Specialized low viscosity trans 1,4-polybutadiene rubber described above with variable Mooney viscosity
³N550, a rubber reinforcing carbon black ASTM designation
⁴Primarily stearic acid (at least 90 percent by weight stearic acid.
⁵Amine and quinoline types
⁶Sulfenamide and quanidine types

The following Table 2 illustrates cure behavior and various physical properties of natural rubber-rich rubber compositions based upon the basic recipe of Table 1 and reported herein as a Control Sample A and Samples B through H. Where cured rubber samples are examined, such as for the Stress-Strain, Rebound, Hardness, Tear Strength and ozone and flex fatigue (crack growth) measurements, the rubber samples were cured for about 12 minutes at a temperature of about 170° C.

TABLE 2

| | Samples (phr) | | | | | | | |
|---|---|---|---|---|---|---|---|---|
| | | Control | | | | | | |
| | A | B | C | D | E | G | H | I |
| Cis 1,4-Polybutadiene (phr) | 60 | 60 | 60 | 60 | 60 | 60 | 60 | 60 |
| Natural cis 1,4-polyisoprene (phr) | 40 | 35 | 30 | 25 | 20 | 15 | 10 | 0 |
| Specialized trans 1,4-polybutadiene w/ | 0 | 5 | 10 | 15 | 20 | 25 | 30 | 40 |
| Mooney (100° C.) viscosity of 32 | | | | | | | | |
| RPA Strain sweep, 100° C.¹ | | | | | | | | |
| Modulus G′, uncured, (KPa) | 170 | 166 | 160 | 159 | 156 | 152 | 149 | 138 |
| 0.83 Hz, 15% strain | | | | | | | | |
| Modulus G′, 10 Hz, 10% | 827 | 816 | 796 | 782 | 756 | 736 | 714 | 671 |
| strain (kPa) | | | | | | | | |
| Tan delta at 10% strain | 0.113 | 0.114 | 0.120 | 0.128 | 0.136 | 0.146 | 0.155 | 0.175 |
| Stress-strain, ATS² | | | | | | | | |
| Tensile strength (MPa) | 12.7 | 12.0 | 12.1 | 11.9 | 11.3 | 10.4 | 9.17 | 6.24 |
| Elongation at break (%) | 647 | 639 | 672 | 697 | 704 | 713 | 700 | 740 |
| 300% modulus (MPa) | 4.3 | 4.2 | 3.9 | 3.7 | 3.5 | 3.1 | 2.8 | 1.8 |
| Shore A hardness, 100° C. | 47 | 46 | 46 | 45 | 45 | 44 | 43 | 38 |
| Rebound, 100° C. | 58 | 56 | 56 | 54 | 53 | 50 | 48 | 42 |
| Tear strength, (self) 95° C., | 161 | 156 | 178 | 216 | 199 | 212 | 204 | 145 |
| (Newtons)³ | | | | | | | | |
| Crack growth resistance⁴ millimeters | 19.7 | 17.7 | 17.5 | 13.5 | 12.1 | 12.1 | 14.3 | 14.4 |
| (mm) of crack growth in 1 hour) | | | | | | | | |
| Static ozone resistance⁵ | | | | | | | | |
| Crack density (No. of cracks) | 0 | 0 | 0 | 0 | 0 | 1 | 1 | 0 |
| Crack severity | 0 | 0 | 0 | 0 | 0 | 1 | 1 | 0 |
| Rank | 1 | 1 | 1 | 1 | 1 | 2 | 2 | 1 |
| Dynamic (cyclic) ozone resistance⁶ | | | | | | | | |
| Crack density (No. of cracks) | 5 | 5 | 5 | 5 | 5 | 5 | 5 | 5 |
| Crack severity | 5 | 5 | 5 | 5 | 4 | 4 | 4 | 4 |
| Rank | 5 | 4 | 3 | 2 | 1 | 1 | 1 | 1 |
| Days (B = sample broke) | 18(B) | 19(B) | 21(B) | 21 | 21 | 21 | 21 | 21 |

¹Data according to Rubber Process Analyzer as RPA 2000 ™ instrument by Alpha Technologies, formerly the Flexsys Company and formerly the Monsanto Company.
²Data according to Automated Testing System instrument by the Instron Corporation which incorporates six tests in one system. Such instrument may determine ultimate tensile, ultimate elongation, modulii, etc. Data reported in the Table is generated by running the ring tensile test station which is an Instron 4201 load frame.
³Data obtained according to a tear strength (peal adhesion) test to determine interfacial adhesion between two samples of a rubber composition. In particular, such interfacial adhesion is determined by pulling one rubber composition away from the other at a right angle to the untorn test specimen with the two ends of the rubber compositions being pulled apart at a 180° angle to each other using an Instron instrument at 95° C. and reported as Newtons force. The area of contact at the interface between the rubber samples is facilitated by placement of a Mylar ™ film between the samples with a cut-out window in the film to enable the two rubber samples to contact each other following which the samples are vulcanized together and the resultant composite of the two rubber compositions used for the peel strength test.
⁴Crack growth resistance measured by a Pierced Groove Flex test conducted at 93° C. at 360 cycles/min using a conical piercing needle 1/32″ in diameter using a 6″ × 1.5″ × 0.25″ sample using 180° flex wherein the flex region is a ¼″ diameter molded groove against the grain of the sample. The results are reported in terms of millimeters of crack growth after one hour.
⁵Static ozone test conditions: 48 hrs; 40° C.; variable strain; 50 pphm ozone (50 parts per 100 million ozone concentration)
⁶Dynamic (cyclic) ozone test conditions: 21 days or until sample breaks; 38° C.; 25 percent strain; 50 pphm ozone.

For the Static and Dynamic ozone tests:

(A) Crack density relates to the number of observed cracks on the surface of a respective Sample where a value of zero means no observed cracks and a value of 1 means a few observed cracks (less than three observed cracks) with progressively higher numbered values representing a progressively larger number of cracks.

(B) Crack severity relates to the average length of the observed cracks in the surface of a respective Sample where a value of zero means no observed cracks and a value of 1 means short observed cracks and progressively higher numbered values mean observed cracks with progressively longer average lengths.

(C) Rank relates to a visual ranking of a respective individual Sample in the respective Table of Samples in terms of a combination of observed crack density and crack severity and whether the Sample breaks during the 21 day test where a value of 1 relates to the Sample with best visual appearance in terms of crack density and crack severity and samples with progressively higher values relate to Samples with a progressively worse visual appearance in terms of a combination of crack density and crack severity.

As hereinbefore pointed out, significant physical properties for the natural rubber/trans 1,4-polybutadiene based rubber composition for a tire sidewall application are Rebound at 100° C. and tan delta at 100° C. which relate to vehicular fuel economy for a tire sidewall with higher values being desired for the Rebound property at 100° C. and lower values being desired for the tan delta property at 100° C.

Higher values of low strain stiffness properties as indicated by the Shore A hardness values and dynamic modulus G′ at 10 percent strain values are desired to promote tire handling and resistance to tire sidewall wear.

Higher tear strength values are normally desired to promote resistance to tire sidewall damage during use of the tire.

Crack growth resistance is important to prevent or retard progressive growth of nicks or cuts that occur in the tire sidewall surface during use of the tire.

Good ozone exposure weathering resistance as measured by an ozone test is important to retard degradation of the sidewall rubber composition in the presence of atmospheric ozone.

From Table 2 it can be seen that the addition of the trans 1,4-polybutadiene has a positive effect of increasing crack growth resistance to values in a range of from 12.1 to 17.7 (millimeters of crack growth in one hour), as compared to a value of 19.7 for Control Sample A which did not contain the trans 1,4-polybutadiene replacement for a portion of the natural rubber.

It is considered herein that this will aid in preventing or retarding growth of nicks and cuts occurring in the tire sidewall surface during tire use.

It is also seen that tear strength is improved by addition of up to 30 phr of the trans 1,4-polybutadiene replacement of the natural rubber as shown by Samples B through H which will help promote resistance to tire sidewall damage during use. However the addition of 40 phr of trans 1,4-polybutadiene replacement did not improve the tear strength as indicated by Sample I.

From Table 2 it can also be seen that the static ozone resistance remains similar to the Control Sample with addition of the trans 1,4-polybutadiene replacement of the natural rubber as can be seen from Samples B through E and I, with exception that at the 25 and 30 phr level of trans 1,4-polybutadiene replacement, Samples G and H exhibited a few very small cracks which is considered herein to be minimal and insignificant. However, the dynamic ozone resistance exhibited improvement with progressive addition of the trans 1,4-polybutadiene as seen in Samples B through I as compared to the Control Sample A.

This is considered herein as being overall significant in the sense of promoting good weathering resistance for the tire sidewall.

Accordingly, it is concluded from this Example that the progressive addition of the trans 1,4-polybutadiene replacement for the natural rubber provided improved tear strength and cut growth resistance while maintaining good ozone weathering resistance.

### EXAMPLE II

Further experiments were conducted to evaluate tack performance of the sidewall rubber composition and also evaluate greater cure density with higher levels of sulfur curative to achieve a better balance of stiffness (e.g. Shore A hardness and G′ modulus values) and hysteresis (e.g. Rebound and tan delta values).

Rubber composition Samples I through L were prepared, with Sample I being a Control Sample which did not contain the trans 1,4-polybutadiene.

The rubber composition samples were prepared in the manner of Example I using the basic formulation for the rubber samples presented in Table 1 of Example I.

The following Table 3 illustrates cure behavior and various physical properties of the natural rubber-rich rubber compositions and reported herein as a Control Sample I and Samples J through L. Where cured rubber samples are examined, such as for the Stress-Strain, Rebound, Hardness, Tear Strength and ozone and flex fatigue (crack growth) measurements, the rubber samples were cured for about 12 minutes at a temperature of about 170° C.

TABLE 3

| | Control | | | |
|---|---|---|---|---|
| | I | J | K | L |
| Samples (phr) | | | | |
| Cis 1,4-Polybutadiene (phr) | 60 | 60 | 60 | 60 |
| Natural cis 1,4-polyisoprene (phr) | 40 | 30 | 20 | 0 |
| Specialized trans 1,4-polybutadiene | 0 | 10 | 20 | 40 |
| Mooney (100° C.) viscosity of 32 | | | | |
| Carbon black | 51 | 50 | 48 | 47 |
| Sulfur curative | 1.24 | 1.35 | 1.5 | 1.65 |
| Surface Tack | | | | |
| Initial, original tack, Newtons | 10.2 | 7.7 | 6.4 | 2.1 |
| Aged tack (air, 5 days, 23° C.) | 11.4 | 7.8 | 5.5 | 0.5 |
| RPA Strain Sweep, 100° C.¹ | | | | |
| Modulus G′, uncured, (KPa) | 177 | 167 | 155 | 125 |
| 0.83 Hz, 15% strain | | | | |
| Modulus G′, at 10% strain (kPa) | 819 | 847 | 850 | 761 |
| Tan delta at 10% strain | 0.102 | 0.108 | 0.106 | 0.126 |
| Stress-strain, ATS, 32 min, | | | | |
| 150° C.² | | | | |
| Tensile strength (MPa) | 10.5 | 10.5 | 9.5 | 9.4 |
| Elongation at break (%) | 677 | 694 | 638 | 720 |
| 300% modulus (MPa) | 3.3 | 3.3 | 3.3 | 2.7 |
| Shore A Hardness, 100° C. | 45 | 46 | 47 | 45 |
| Rebound, 100° C. | 56 | 56 | 57 | 54 |
| Tear strength, (self) 95° C., | 120 | 143 | 145 | 154 |
| (Newtons)³ | | | | |
| Flex fatigue⁴ (mm crack | 16.2 | 23.3 | 25.4(B) | 25.4(B) |
| growth in 1 hour) | | | | |
| (*B = Sample broke during test) | | | | |
| Static ozone resistance⁵ | | | | |
| Crack density (No. of cracks) | 4 | 2 | 1 | 0 |
| Crack severity | 2 | 1 | 1 | 0 |
| Rank | 4 | 3 | 2 | 1 |
| Dynamic (cyclic) ozone resistance⁶ | | | | |
| Crack density (No. of cracks) | 5 | 5 | 5 | 5 |
| Crack severity | 6 | 6 | 4 | 4 |
| Rank | 3 | 2 | 1 | 2 |
| Days (B = sample broke) | 15(B) | 21(B) | 21 | 21 |

The tests referenced in the above Table 3 were conducted in the manner reported for Table 2 of Example I.

As hereinbefore pointed out, significant physical properties for the natural rubber/cis 1,4-polybutadiene based rubber composition for a tire sidewall application are Rebound at 100° C., tan delta at 100° C., Shore A hardness, and dynamic modulus (G′) at low (10 percent) strain.

For this Example, as hereinbefore indicated, an increase in the level of sulfur curative content is evaluated in a sense of increasing cure density to provide higher stiffness and lower hysteresis for a respective Sample.

From Table 3 it can be seen that that the G′ modulus at 10 percent strain for Samples J through L is similar to the Control Sample I which did not contain the trans 1,4-polybutadiene.

This is considered herein to be significant in a sense of promoting good handling and wear resistance for the sidewall.

From Table 3 it can also be seen that the tan delta at 10 percent strain is similar to the Control at 10 phr (Sample J) and 20 phr (Sample K) of the trans 1,4-polybutadiene addition and slightly higher at 40 phr (Sample L) of the trans 1,4-polybutadiene replacement.

It can be seen from Table 3 that the Rebound values are also similar to the Control Sample I at 10 phr (Sample J) and 20 phr (Sample K) but lower at 40 phr (Sample L) of trans 1,4-polybutadiene addition.

It can also be seen from Table 3 that the Tack properties showed a steady drop in value with the progressive addition of the trans 1,4-polybutadiene and the Tack is considered herein to be unacceptable at the 40 phr level (Sample L) of trans 1,4-polybutadiene replacement for the natural rubber.

It can further be seen from Table 3 that Flex fatigue cut growth resistance became slightly worse with the progressive addition of the trans 1,4-polybutadiene, however static and dynamic ozone resistance values indicated a progressive improvement as compared to the Control Sample I.

It is considered herein that the cis 1,4-polyisoprene rubber (the natural rubber) is needed in the rubber composition to maintain adequate tack for assembling tire rubber components for the building of the tire assembly of components.

### EXAMPLE III

Additional experiments were conducted to evaluate an effect of Mooney viscosity of the uncured trans 1,4-polybutadiene.

Rubber composition Samples M through P were prepared, with Sample M being a Control Sample which did not contain the trans 1,4-polybutadiene. The rubber composition samples were prepared in the manner of Example I using the basic formulation for the rubber samples presented in Table 1 of Example I.

The following Table 4 illustrates cure behavior and various physical properties of the natural rubber-rich rubber compositions and reported herein as a Control Sample M and Samples N through P. Where cured rubber samples are examined, such as for the Stress-Strain, Rebound, Hardness, Tear Strength and ozone and flex fatigue (crack growth) measurements, the rubber samples were cured for about 12 minutes at a temperature of about 170° C.

TABLE 4

| | Control | | | |
|---|---|---|---|---|
| | M | N | O | P |
| Samples | | | | |
| Cis 1,4-Polybutadiene (phr) | 60 | 65 | 65 | 65 |
| Natural cis 1,4-polyisoprene (phr) | 40 | 25 | 25 | 25 |
| Specialized trans 1,4-polybutadiene | 0 | 10 | 10 | 10 |
| Mooney, of trans | — | 16 | 32 | 79 |
| 1,4-polybutadiene, | | | | |
| (100° C.), (ML + 4) | | | | |
| Carbon black | 51 | 49 | 49 | 49 |
| RPA Strain sweep, 100° C.¹ | | | | |
| Modulus G′, uncured, (KPa) | 145 | 132 | 133 | 149 |
| 0.83 Hz, 15% strain | | | | |
| Modulus G′, at 10% strain (kPa) | 806 | 738 | 761 | 815 |
| Tan delta at 10% strain | 0.098 | 0.106 | 0.104 | 0.099 |
| Stress-strain, ATS, 32 min, | | | | |
| 150° C.² | | | | |
| Tensile strength (MPa) | 11.2 | 9.8 | 10.2 | 10.6 |
| Elongation at break (%) | 722 | 732 | 734 | 740 |
| 300% modulus (MPa) | 3.4 | 2.9 | 3 | 3 |
| Shore A hardness, 100° C. | 45 | 44 | 45 | 46 |
| Rebound, 100° C. | 59 | 56 | 57 | 59 |
| Tear strength, (self), 95° C., | 152 | 170 | 169 | 160 |
| (Newtons)³ | | | | |
| Flex fatigue (mm crack growth | 16.5 | 14.4 | 17.3 | 24.1 |
| in 1 hour)⁴ | | | | |
| Static ozone resistance⁵ | | | | |
| Crack density (No. of cracks) | 4 | 4 | 4 | 4 |
| Crack severity | 3 | 3 | 3 | 3 |
| Rank | 5 | 1 | 3 | 1 |
| Dynamic (cyclic) ozone resistance⁶ | | | | |
| Crack density (No. of cracks) | 5 | 5 | 5 | 5 |
| Crack severity | 6 | 4 | 5 | 5 |
| Rank | 5 | 3 | 4 | 1 |
| Days (B = sample broke) | 16(B) | 21 | 21 | 21 |

The tests referenced in the above Table 4 were conducted in the manner reported for Table 2 of Example I.

It can be seen from Table 4 that, although an increase of the Mooney viscosity from 16 to 79 (Samples N through P) has a negligible effect on most properties of the Samples as compared to Control Sample M which did not contain the trans 1,4-polybutadiene. The increase in the Mooney viscosity is seen to have a dramatic negative effect on the flex fatigue, or cut growth resistance, as shown by Sample P as compared to the Control Sample M.

On the other hand, it can be seen from Table 4 that a decrease in the Mooney viscosity from 32 to 16 was observed to have a positive effect on flex fatigue, crack growth resistance as shown by Sample N compared to Sample O, without significantly affecting the other physical properties.

It is therefore considered herein that the observed results of using the trans 1,4-polybutadiene with a Mooney viscosity 16 to 32 provided the best opportunity of replacing a portion of the natural rubber with the trans 1,4-polybutadiene.

While certain representative embodiments and details have been shown for the purpose of illustrating the invention, it will be apparent to those skilled in this art that various changes and modifications may be made therein without departing from the spirit or scope of the invention.

1. A tire having an outer, visible, rubber sidewall wherein said sidewall is a rubber composition comprised of, based upon parts by weight per 100 parts by weight rubber (phr):
(A) from about 5 to about 35 phr of a specialized trans 1,4-polybutadiene polymer having a microstructure containing from about 70 to about 90 percent trans 1,4-units, a cis 1,4-content in a range of from about 20 percent and a vinyl 1,2-content in a range of from about 3 to 5 percent, a Mooney (ML 1+4) viscosity at 100° C. in a range of from 10 to 45 in its uncured state, and a Tg in a range of from about -85° C. to about -95° C.;
(B) from about 10 to about 40 phr of cis 1,4-polyisoprene rubber comprised of at least one of natural and synthetic cis 1,4-polyisoprene rubber having a Mooney (ML 1+4) viscosity (100° C.) in a range of about 60 to about 100 in its uncured state;
(C) from about 50 to about 70 phr cis 1,4-polybutadiene rubber; and
(D) from about 30 to about 80 phr of particulate reinforcing fillers comprised of:
(1) about 30 to about 80 phr of rubber reinforcing carbon black, and
(2) from zero to about 30 phr of precipitated silica
wherein said specialized trans 1,4-polybutadiene has a weight average molecular weight (Mw) below 220,000 and a number average molecular weight (Mn) below 120,000, and
wherein said specialized trans 1,4-polybutadiene polymer is the product of polymerization of 1,3-butadiene in an organic solvent in the presence of a catalyst composite consisting essentially of
(A) the barium salt of di(ethylene glycol) ethylether (BaDEGEE), tri-n-octylaluminum (TOA) and n-butyl lithium (n-BuLi), so long the resulting trans 1,4-polybutadiene polymer is said specialized trans 1,4-polybutadiene polymer, or
(B) the barium salt of di(ethylene glycol) ethylether (BaDEGEE), amine, ti-n-octylaluminum (TOA) and n-butyl lithium (n-BuLi), wherein said amine is selected from n-butyl amine, isobutyl amine, tert-butyl amine, pyrrolidine, piperidine and TMEDA (N, N, N′,N′-tetramethylethylenediamine so long as the resulting trans 1,4-polybutadiene polymer is the said specialized trans 1,4-polybutadiene polymer.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

19. (canceled)

20. (canceled)
